(19) United States
(12) Patent Application Publication
(10) Pub. No.: US 2004/0238302 A1
(43) Pub. Date: Dec. 2, 2004

(54) Braking buffer and turning balance device for motorcar

(76) Inventor: Yi-Hsung Pang, Hsinchu (TW)

Correspondence Address: PERKINS COIE LLP, P.O. BOX 2168, MENLO PARK, CA, 94026, US

(21) Appl. No.: 10/679,051

(22) Filed: Oct. 2, 2003

(30) Foreign Application Priority Data
May 26, 2003 (TW) 092114199

(51) Int. Cl. F16F 7/10

(52) U.S. Cl. 188/380

(57) ABSTRACT

The present invention discloses a braking buffer and a turning balance device for motorcar. The brake buffer device mainly made of a weighty drum with a fixed mass and a recover spring, to fix it on the left and right sides of the body base of a car longitudinally. When the car is braking, the momentum of the sudden push will transfer to the weighting such that will decrease the braking distance and forward pushing of the driver and the persons on the car. The turning balance device is fixed on the rear of the body base under the trunk of a car horizontally, and keep the distance from the axis of the front wheel as long as possible. When the car is turning, the momentum caused by the outward centrifugal force will transfer to the weighting such that turning radius will decrease and the turning will become more balance. These increases stability and safety.

### BACKGROUND OF THE INVENTION

1. Field of the Invention

The present invention relates to mechanical braking buffer and a turning balance device. In particular, the present invention relates to implementing of momentum transfer, which transfer the momentum temporary to a weighty drum, this mechanical device then increase the comfortable and safety of a car.

2. Description of the Related Art

Generally the improvement of the braking system of a car such as Anti-lock Brake System (ABS), which prevents slipping cause by locking of the wheel, increases safety by preventing the steering wheel out of control. However, this anti-lock brake system is electrical and sensing system, still has its limit. This system has little contribution to decrease the braking distance. For the improvement of the safety during turning, such as differential gear, which makes difference rotation rates of the left wheel and the right wheel, such that turning will become smooth. The other improvements such as the soft seat, the seat belts, the handle beside the seat can also increase the safety and comfortable. All of these can not decrease the uncomfortable and dangerous cause by the push and centrifugal force during braking and turning.

What is needed is an improved mechanical device satisfied the need of comfortable and safety such that the uncomfortable feeling caused by the push when braking and unbalanced caused by the centrifugal force during turning can be decreased, and stable, comfortable, safety can be increased. It also need not use expensive and very accurate method to manufacture the device.

### OBJECTS OF THE INVENTION

It is therefore an object of the invention to provide an improved braking buffer device for motorcar. The device will transfer the momentum temporary to a weighty drum when braking, this will decrease the pushed feeling of the driver and the customer, increasing the comfortable when braking.

It is another object of the invention to provide an improved braking buffer device for motorcar. By implement a simple mechanical device to decrease the braking distance, and increase safety when braking.

It is yet another object of the invention to provide an improved turning balance device for motorcar. The device will transfer the momentum of the outward centrifugal force temporary to a weighty drum when the car is turning, thus increases comfortable.

It is yet a further object of the invention to provide an improved turning balance device for motorcar. The device will decrease the radius of turning by decreasing the outward centrifugal force of the front wheel, and decrease the wear down of the tires, thus increasing safety of the driver and the passengers.

### DISCLOSURE OF THE INVENTION

A first aspect of the present invention teaches a braking buffer device for motorcar, installing one braking buffer device at the left side and another one at the right side under the body of a car, by transferring the momentum temporary to a weighty drum when braking to decrease the braking distance, increasing the comfortable and safety of the car, every device comprising: A supporting frame, fixing longitudinally under the body of a car between the front wheel and the rear wheel, to support the front and rear end plate, guiding axis, recover spring, buffer spring and weighty drum; A guiding axis, guiding the position of the weighty drum and the spring to slide forward or backward; two front and rear end plates, fixing on the two end of the supporting frame, for supporting the guiding axis; A weighty drum, sliding along the guiding axis for absorbing momentum; A recover spring, for recover the original position of the weighty drum; A buffer spring, for buffering and noise absorption during the recovering of the recover spring; A fixing mechanism, for fixing the supporting frame on the body of a car.

Another preferred embodiment of the present invention teaches a turning balance device for motorcar, by transferring the momentum of the centrifugal force temporary to a weighty drum when the car is turning, to decrease the centrifugal momentum of the front wheel, thus increases safety, comprising: A supporting frame, fixing transversely under the body of a car near the trunk, to support the left and right end plate, guiding axis, recover spring and weighty drum; A guiding axis, guiding the position of the weighty drum and the spring to slide to the left or to the right; Two left and right end plates, fixing on the two end of the supporting frame, for supporting the guiding axis; A weighty drum, sliding along the guiding axis for absorbing momentum; A recover spring, for recover the original position of the weighty drum; A fixing mechanism, for fixing the supporting frame on the body of a car.

### BRIEF DESCRIPTION OF THE DRAWINGS

The foregoing and other advantages of the invention will be more fully, understood with reference to the description of the best embodiment and the drawing wherein:

FIG. 1 is a schematic representation of the structure of a braking buffer device in according to one embodiment of the present invention.

FIG. 2 is a schematic representation of the position of the weighty drum in the instance after braking.

FIG. 3 is a schematic representation of the structure of a turning balance device in according to one embodiment of the present invention.

FIG. 4 is a schematic representation of the weighty drum slipping to the left due to the centrifugal force when the car turning to the right.

FIG. 5 illustrates the example set up of two braking buffer devices and one turning balance device under the body of a car.

### DESCRIPTION OF THE PREFERRED EMBODIMENTS

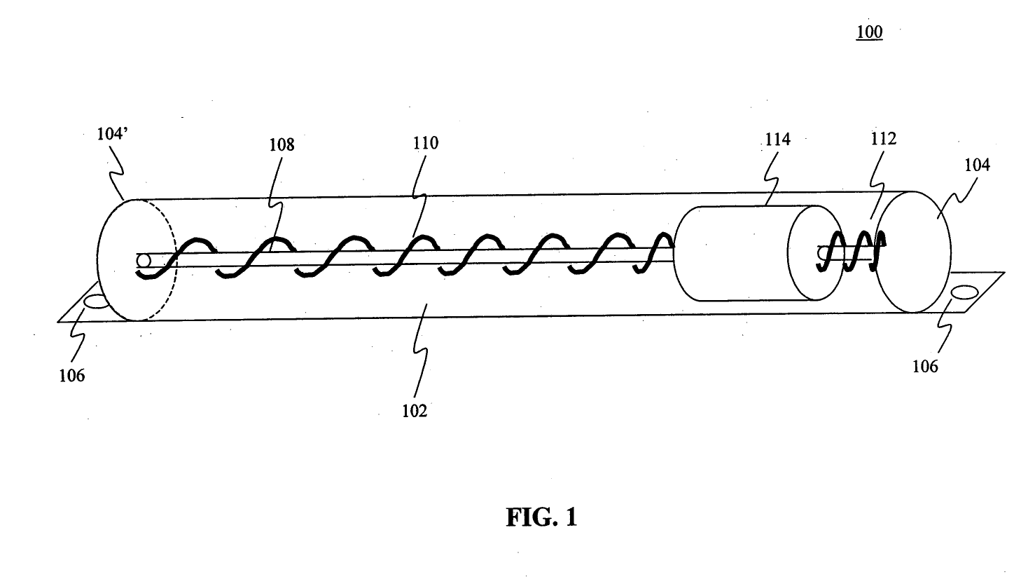

Referring to FIG. 1, FIG. 1 is a schematic representation of the structure of a braking buffer device 100 in according to one embodiment of the present invention. Supporting frame 102 is a hollow cylinder, or other shapes compatible with the space of installation under the car, enable to support the momentum of the weighty drum 114 and the counter force of the spring 110, and generally to be stainless steel or plastic. Two fitting screw holes 106 on both ends are used to fix the support frame on the body of a car. Every car generally installs two set of braking buffer 100 on the left and the right sides. Front end plate 104′ and rear end plate 104 are fixed on the two sides of the supporting frame 102 to support the guiding axis 108, The weighty drum 114, the recover spring 110 and the buffer spring 112 are guiding by the guiding axis 108. The recover spring releases potential energy after braking is completed, which takes the drum 114 to recover its original position. The recover spring 110 can be replaced by pneumatic. The buffer spring 112 can be replaced by a elastic rubber. The guiding axis go through the sliding hole of the weighty drum such that the weighty drum can slide along it, and will slide forward along the arrow 116 by inertia during braking. Assume that the mass of the drum is m, the velocity of the car is v₁, the momentum when braking is then:

Momentum of the weighty drum=mv₁ (1)

At this time, the car is braking, the velocity of the car decreases to v₂, where v₂<v₁, assume that the mass of the car is M, the momentum changed is then:

Momentum changed=Mv₁−Mv₂=M(v₁−v₂) (2)

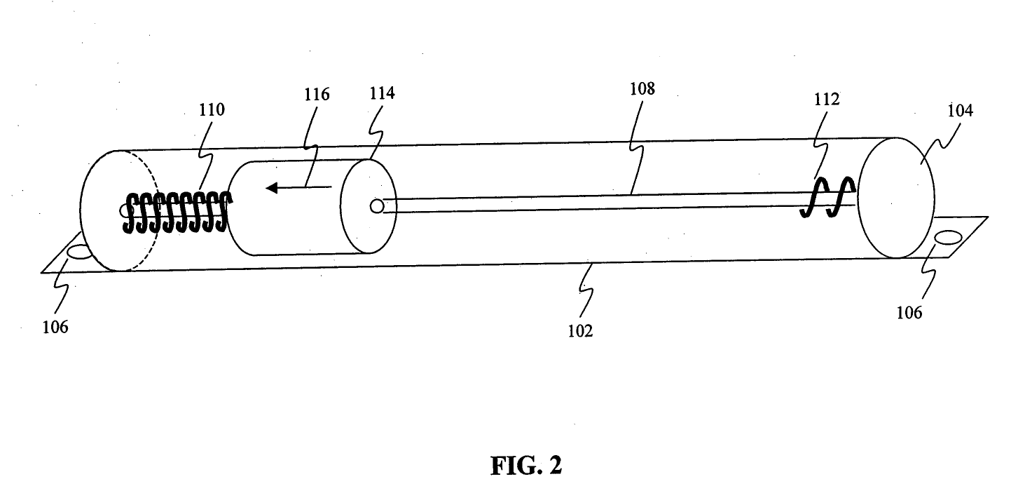

The change of momentum makes the driver and the passengers feel a pushing, part of the momentum change to the momentum of the weighty drum, thus decreases the push feeling by the driver and the passengers. Till the braking is completed, the momentum of the weighty drum is struck against the car and changed to part of the momentum of the car (part of the momentum changes to potential energy) through the spring and the body of the car. However, on this time, the braking is already completed, the strike is not essential to the driver and the passengers. Now the weighty drum stops on the front-end position, as shown in FIG. 2. FIG. 2 is a schematic representation of the position of the weighty drum in the instance after braking. One can see in FIG. 2, The recover spring 110 is compressed and storing potential energy, but the buffer spring 112 still in its original position because it does not connect with the weighty drum. Once the weighty drum 114 approaches the most front end of the rear end plate 104, the weighty drum 114 is pushed back to its original position by the recover spring 110, as shown in FIG. 1. When the weighty drum 114 approaches the most front end of the rear end plate 104, the motorcar may still moving forward, and braking is still in process. The action of pushing back the weighty drum 114 to its original position by the recover spring 110 causing the weighty drum 114 shoot off backward and touch the rear end plate 104, Then the motorcar receives a backward force and once more help braking, so that the speed of the car once more decreasing to help braking. The shape of the weighty drum is the same as the supporting frame, may be round shaped or other shapes to match the shape of the supporting frame, i.e. to match the shape of the installing space. More mass of the weighty drum is the better, depends on the size of the car. In order to decrease the volume, lead is the better material, stainless steel or ion could be used to decrease pollution.

Each one of the braking buffer devices for motorcar is installed on the left and the right side. In one embodiment, the braking buffer devices are installing longitudinally and horizontally at the left side and another one at the right side under the body of a car. In another embodiment, the braking buffer devices are installing longitudinally and tilt the front end 1° to 4° downwardly at the left side and another one at the right side under the body of a car, thus the weighty drum will produce a downward component of force on the front and the rear wheel, but most of the force is applied to the front wheel, which increases the grasp on the ground firmly and increases frictional force of the four wheels, thus preventing slipping of the four wheels, this also a help to decrease the braking distance. In emergency braking, the weighty drum pressing downwardly and forwardly, this may decrease the possibility of turn over and increase the safety of the car, especially in turning. The weigh of the weighty drum may also increase the stability and is hard to turn over. Furthermore, there are two braking buffer devices installed on both side, the weigh of the braking buffer device is installed at the lowest position from the ground, thus enforces the stability when emergency braking during turning, so decreases the possibility of turn over of the car.

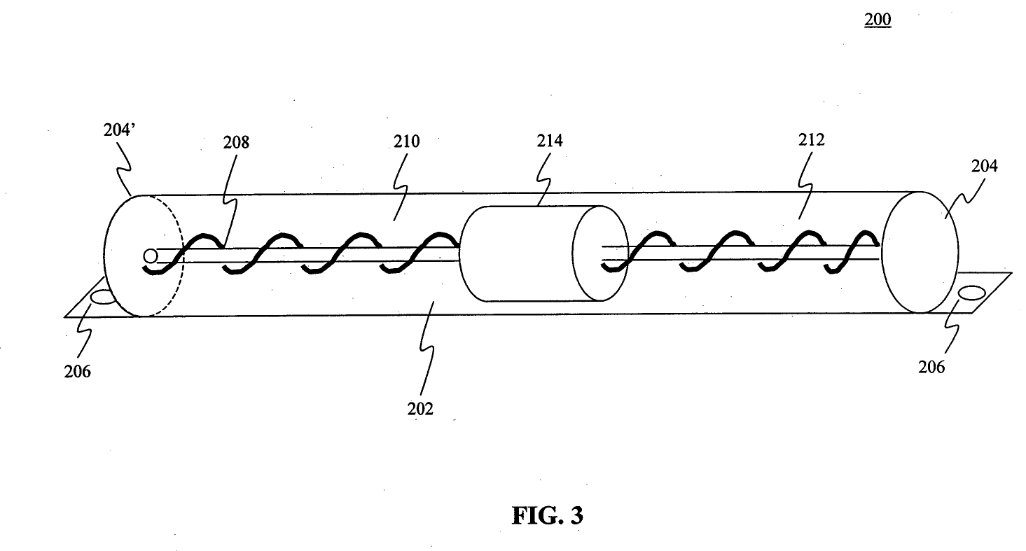

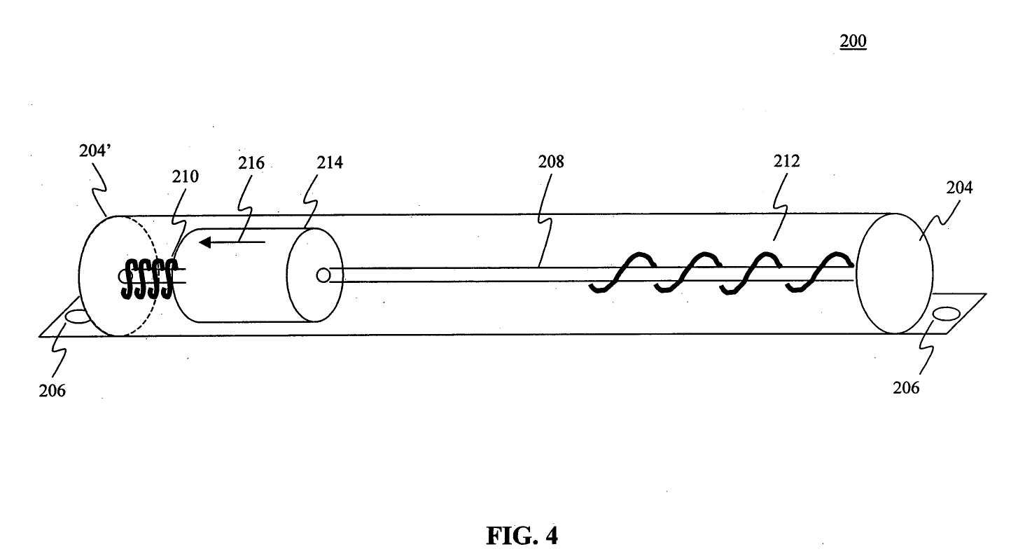

FIG. 3 is a schematic representation of the structure of a turning balance device in according to one embodiment of the present invention. The turning balance device 200 is difference from the braking buffer device 100 by the weighty drum 214, which is put in the central position, and both side are recover spring 210 and 212, supporting frame 202 is fixed transversely on the rear part of the body under the trunk or in the rear bumper. The better the distance from the front axis of the wheel is larger. Left end plate 204′ and right end plate 204 are fixed on the two sides of the supporting frame 202 to support the guiding axis 208, The weighty drum 214, recover spring 210 and 212. The guiding axis 208 go through the sliding hole of the weighty drum 214 such that the weighty drum 214 can slide along it to the left side or the right side, for example, when turn to the right, refer to FIG. 4, FIG. 4 is a schematic representation of the weighty drum slipping to the left due to the centrifugal force when the car turning to the right. Assume that the mass of the weighty drum is m, when accelerates to a speed of v₃, the momentum will be:

Momentum=mv₃ (3)

Since the left front tire has frictional force with the ground, the speed of outward is nearly zero. But if the centrifugal force is too large, the frictional force is smaller than the centrifugal force, then the front tire will slip outwardly and forwardly. This will increase the turning radius, the momentum of slipping is ft=Mv₄, where f is the centrifugal force, t is the time of slipping, M is the mass of the car and v₄ is the average speed of slipping, then the momentum of slip is Mv₄. But if the weighty drum sliding to the left side freely, since no frictional force, its velocity v₃ is larger than the slipping velocity v₄ of the car, thus transfer the momentum temporary to the weighty drum, and the momentum ft=mv₄ is absorbed by the body when the weighty drum reached the most left end, and producing an outward force f=mv₄/t, this force produces a torque to assist the car to rotate toward the turning direction, and the front tire would not slip outwardly and forwardly, thus decreases the radius of turning, and decreases the wear down of the tires, increases the balance and safety of the driver and the car. It also decreases tilting, so increases the comfortable of the passengers. When the turning is completed, the weighty drum 214 is blocking by the left end plate and the right end plate and releasing momentum and transform to a pushing force, but in this time, turning has been completed, this pushing is not important to the driver and the passengers. Now the weighty drum stop on the left end position, as shown in FIG. 4. The left recovered spring 210 being compressed and storage potential energy, but the right recovered spring 212 still in its original position, since the recover springs do not connect with the weighty drum. Once turning is completed, the recover spring 210 will push the weighty drum to its original position, as shown in FIG. 3. For left turn, the weighty drum 214 will slide to the right. The operation is the reversal of FIG. 4.

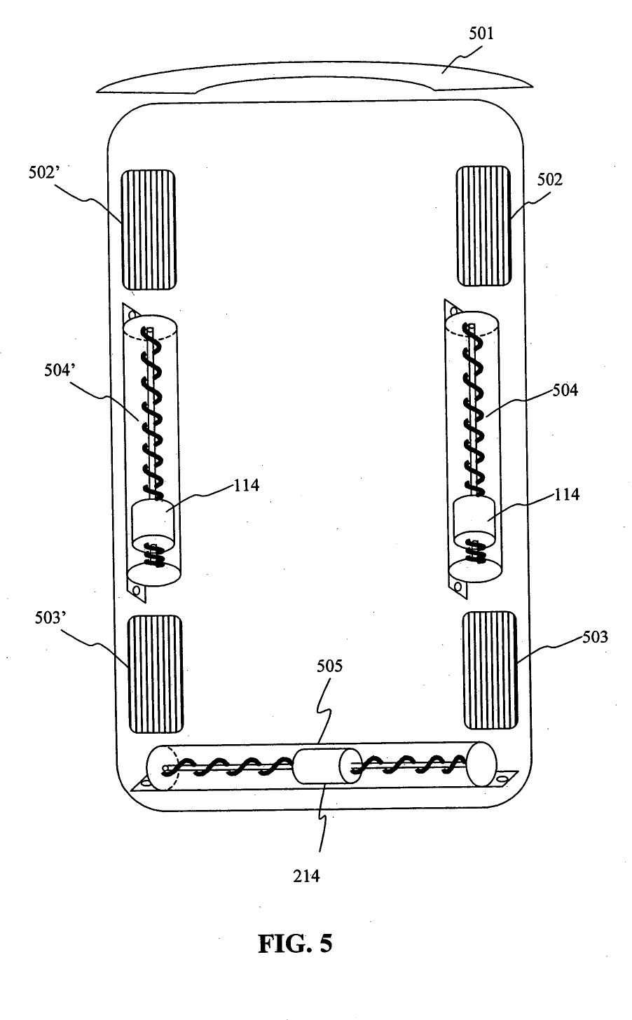

FIG. 5 illustrates the example set up of the two braking buffer devices and one turning balance device under the body of a car. One of the braking buffer device 504 is installed between the right front tire 502 and the right rear tire 503 longitudinally. Another braking buffers device 504′ is installed between the left front tire 502′ and the left rear tire 503′ longitudinally. The turning balance device 505 is installed behind and under the trunk transversely, as shown in FIG. 5.

Although specific embodiments of the invention have been disclosed, it will be understood by those having skill in the art that minor changes can be made to the form and details of the specific embodiments disclosed herein, without departing from the spirit and the scope of the invention. The embodiments presented above are for purposes of example only and are not to be taken to limit the scope of the appended claims.

1-11. (canceled)

12. A braking buffer device for a motorcar having a front and a back, said braking buffer device intended to provide a more comfortable braking experience for passengers of said motorcar, said braking buffer device comprising:
a guiding axis coupled from said front to said back of said motorcar;
a weighty drum movably fixed along said guiding axis, said guiding axis confining motion of said weighty drum between said front and said back of said motorcar, said weighty drum having a predefined resting position upon said guiding axis; and
a recovery device tending to bias said weighty drum to said predefined resting position.

13. A braking buffer device as recited in claim 12, wherein said guiding axis is coupled to an underside of said motorcar.

14. A braking buffer device as recited in claim 13 further comprising a supporting frame, said supporting frame coupled to said underbody of said automobile, said supporting frame enclosing said guiding axis, said weighty drum, and said recovery device.

15. A braking buffer device as recited in claim 14, wherein said supporting frame is a substantially hollow cylindrical body.

16. A braking buffer device as recited in claim 12, wherein said recovery device includes a coiled spring.

17. A braking buffer device as recited in claim 12, wherein said recovery device includes a pneumatic device.

18. A braking buffer device as recited in claim 12, wherein said recovery device includes elastic rubber.

19. A braking buffer device as recited in claim 12 further comprising a buffer device for buffering and noise absorption during a recovery cycle of said weighty drum.

20. A braking buffer device as recited in claim 19, wherein said buffer device includes a spring.

21. A braking buffer device as recited in claim 19, wherein said buffer device includes a pneumatic device.

22. A braking buffer device as recited in claim 19, wherein said buffer device includes elastic rubber.

23. A braking buffer device as recited in claim 12, wherein said guiding axis is tilted down towards said front of said motorcar.

24. A braking buffer device as recited in claim 23, wherein said tilt of said guiding axis is between about 1-4 degrees.

25. A braking buffer device as recited in claim 12, wherein said predefined resting position of said weight drum is positioned towards said back of said motorcar.

26. A braking buffer device for a motorcar having a front and a back, said braking buffer device intended to provide a more comfortable braking experience for passengers of said motorcar, said braking buffer device comprising:
a guiding axis coupled from said front to said back of said motorcar, said guiding axis being tilted downward towards said front of said motorcar;
a weighty drum movably fixed along said guiding axis, said guiding axis confining motion of said weighty drum between said front and said back of said motorcar, said weighty drum having a predefined resting position upon said guiding axis positioned towards said back of said motorcar; and
a recovery device tending to bias said weighty drum to said predefined resting position.

27. A breaking buffer device for a motorcar travelling in a longitudinal direction, said breaking buffer device characterized such that said breaking buffer device operates to temporally transfer longitudinal momentum to a weighty drum that is biased to the rear of said motorcar when breaking thereby tending to increase the comfort and safety of the car.

28. A car suitable for the transportation of passengers and cargo comprising:
a left braking buffer device having a front and a back, said braking buffer device intended to provide a more comfortable braking experience for passengers of said car, said braking buffer device including:
a left guiding axis coupled from said front to said back of said car;
a left weighty drum movably fixed along said left guiding axis, said left guiding axis confining motion of said left weighty drum between said front and said back of said car, said left weighty drum having a predefined resting position upon said left guiding axis; and
a left recovery device tending to bias said left weighty drum to said predefined resting position;
a right braking buffer device having a front and a back, said right braking buffer device intended to provide a more comfortable braking experience for passengers of said car, said right braking buffer device including:
a right guiding axis coupled from said front to said back of said car;
a right weighty drum movably fixed along said right guiding axis, said right guiding axis confining motion of said weighty drum between said front and said back of said car, said right weighty drum having a predefined resting position upon said right guiding axis; and
a right recovery device tending to bias said right weighty drum to said predefined resting position;
a rear turning balance device having a left and a right, said rear turning balance device intended to decrease centrifugal motion of front wheels of said car, thereby increasing safety, including:
a rear guiding axis coupled from said left to said right of said car;
a rear weighty drum movably fixed along said rear guiding axis, said rear guiding axis confining motion of said rear weighty drum between said left and said right of said car, said rear weighty drum having a predefined resting position upon said rear guiding axis; and
a rear recovery device tending to bias said weighty drum to said predefined resting position.

29. A car as recited in claim 28, wherein said left and right guiding axes in said left and right braking buffer devices are tilted downward towards said front of said car at a guiding axis tilt.

30. A car as recited in claim 29, wherein said guiding axis tilt is between about 1-4 degrees.
